(19) United States
(12) Patent Application Publication
(10) Pub. No.: US 2007/0130564 A1
(43) Pub. Date: Jun. 7, 2007

(54) Storage performance monitoring apparatus

(76) Inventor: Yusuke Fukuda, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/299,750

(22) Filed: Dec. 13, 2005

(30) Foreign Application Priority Data
Oct. 21, 2005 (JP) 2005-306943

(51) Int. Cl. G06F 9/44

(52) U.S. Cl. 717/168

(57) ABSTRACT

The present invention relates to a computer system, more particularly to a computer system for reducing a performance load generated by the operation of a program for obtaining performance information of a storage system. A performance information collecting method executed in a computer system comprising: the performance information collecting method comprises: a first step of obtaining, by the control unit, the performance information of the storage system; a second step of transmitting, by the control unit, the obtained performance information to the host computer having a lower load than a predetermined threshold value; a third step of transmitting, by the host computer, the performance information transmitted from the control unit to the management computer; and a fourth step of collecting, by the management computer the transmitted performance information.

### CLAIM OF PRIORITY

The present application claims priority from Japanese application P2005-306943 filed on Oct. 21, 2004, the content of which is hereby incorporated by reference into this application.

### BACKGROUND

The present invention relates to a computer system, and more particularly to a computer system for reducing a performance load generated by the operation of a program for obtaining performance information of a storage system.

In a computer system provided with a storage system including a control device for inputting and outputting data in a disk drive in response to a request from a host computer, there is a demand for collecting performance information of the storage system for the operation of the computer system.

The performance information of the storage system includes, for example, the number of I/Os from a host computer, the data amount of I/Os from the host computer, a load on a processor of a control device, the number of I/Os from the control device, disk drive utilization, and the like.

The performance information of the storage system are generally obtained by a program operating on a host computer or a management computer, as described in, for example, JP 2003-316522 A

### SUMMARY

However, the program for collecting the performance information of storage system or the like generates a load on the resources of the program itself. Therefore, the conflict between a particular user program and the resources is generated or a load on I/Os or the like is generated by the program to prevent the number of I/Os of the performance information from being precisely counted in some cases.

The present invention is devised in view of the problem described above, and has an object of providing a computer system that determines how to operate a program for obtaining performance information of a storage system to obtain performance information with higher accuracy.

According to an aspect of this invention relates to a performance information collecting method executed in a computer system comprising: a disk drive, in which at least one logical area that stores data is set; a storage system comprising a control unit that controls read and write of data from and to the disk drive and an interface connected to a host computer; the host computer connected to the interface through a network, the host computer making a request of read and write of data from and to the logical area of the disk drive; and a management computer that collects performance information of the storage system, the network and the host computer; wherein a correlation between the host computer and the logical area used by the host computer is set; and the performance information collecting method comprises: a fist step of obtaining, by the control unit, the performance information of the storage system; a second step of transmitting, by the control unit, the obtained performance information to the host computer having a lower load than a predetermined threshold value; a third step of transmitting, by the host computer, the performance information transmitted from the control unit to the management computer; and a fourth step of collecting, by the management computer, the transmitted performance information.

According to this invention, in a computer system, performance information obtained by a control unit of a storage system is transmitted to a management computer through a host computer with a low load. Thus, the effects on the operation being executed on the computer system can be kept to a minimum. At the same time, more precise performance information can be obtained.

### BRIEF DESCRIPTION OF THE DRAWINGS

FIG. 1 is a block diagram showing a configuration of a computer system according to an embodiment of this invention.

FIG. 2 is a functional block diagram of a first agent program according to the embodiment of this invention.

FIG. 3 is a functional block diagram of a second agent program according to the embodiment of this invention.

FIG. 4 is a functional block diagram of a client program according to the embodiment of this invention.

FIG. 5 is a configuration block diagram of a manager program according to the embodiment of this invention.

FIG. 6 is an explanatory view of the first agent program according to the embodiment of this invention.

FIG. 7 is an explanatory view of an example of a data format of performance information according to the embodiment of this invention.

FIG. 8 is an explanatory view of an example of a setting information table according to the embodiment of this invention.

FIG. 9 is an explanatory view of an example of install target information according to the embodiment of this invention.

FIG. 10 is an explanatory view of an example of an obtained data time information management table according to the embodiment of this invention.

FIG. 11 is an explanatory view of an example of a node information table according to the embodiment of this invention.

FIG. 12 is a sequence diagram of a processing of distributing the agent programs according to the embodiment of this invention.

FIG. 13A is a flowchart of a processing of changing a storage location of the first agent program according to the embodiment of this invention.

FIG. 13B is a sequence diagram of the processing of changing the storage location of the first agent program according to the embodiment of this invention.

FIG. 13C is another sequence diagram of the processing of changing the storage location of the first agent program according to the embodiment of this invention.

FIG. 14 is an explanatory view of an example of a performance information correspondence table according to the embodiment of this invention.

FIG. 15 is a flow chart of an alarm notification according to the embodiment of this invention.

FIG. 16 is an explanatory view of an example of an alarm state management table according to the embodiment of this invention.

FIG. 17 is a sequence diagram of a processing of collecting data according to the embodiment of this invention.

FIG. 18A is an explanatory view of distribution of the performance information according to the embodiment of this invention.

FIG. 18B is an explanatory view of distribution of the performance information according to the embodiment of this invention.

FIG. 18B is an explanatory view of distribution of the performance information according to the embodiment of this invention.

### DETAILED DESCRIPTION OF THE INVENTION

Hereinafter, an embodiment of this invention will be described with reference to the accompanying drawings.

According to the embodiment of this invention, in a computer system, performance information of a storage system 30 is obtained by a program (a first agent program 3000) for obtaining the performance information stored in the storage system 30. Then, the obtained performance information is transmitted to an integration management server 10 for collecting the performance information through a program (a second agent program 2000) stored in a host computer 20.

First, a configuration of the computer system will be described.

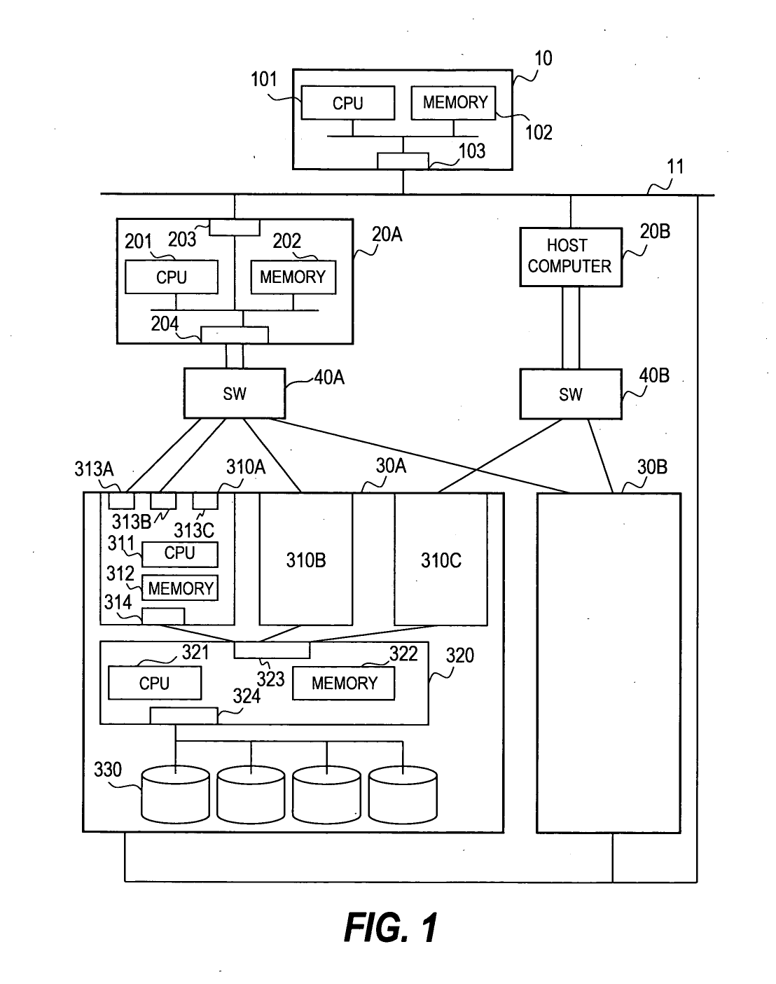

FIG. 1 is a block diagram showing the configuration of the computer system according to a first embodiment of this invention.

The computer system according to this embodiment of this invention includes the integration management server 10, host computers 20A and 20B, storage systems 30A and 30B, and switches (SWs) 40A and 40B.

The host computers 20A and 20B make a request to read and write data stored in the storage systems 30A and 30B. Each of the storage systems 30A and 30B includes a disk drive 330 so as to process the request to read and write the data stored in the disk drive 330 from the host computers 20A and 20B. The integration management server 10 obtains the performance information of the host computers 20A and 20B, the storage systems 30A and 30B, and the like so as to inform of statistical information or an alert (an error) regarding the obtained performance information.

The host computer 20A is connected to the storage systems 30A and 30B through the SW 40A, whereas the host computer 20B is connected to the storage systems 30A and 30B through the SW 40B. The connections between the host computers 20A and 20B and the SWs 40A and 40B and between the SWs 40A and 40B and the storage systems 30 are realized by a network suitable for data transfer such as an FC (Fiber Channel) or an SCSI.

The integration management server 10 is connected to the host computers 20A and 20B and the storage systems 30A and 30B through the network 11. The network 11 is configured with a network such as an Ethernet.

The integration management server 10 includes a CPU 101, a memory 102, and an interface 103.

The CPU 101 reads a program stored in the memory 102 so as to execute a process defined by the program. The memory 102 stores various programs, data used by the programs, and the like. The interface 103 transmits/receives data to/from the host computer 20A and 20B, the storage systems 30A and 30B through the network 11.

The host computer 20A includes a CPU 201, a memory 202, interface 203, and an interface 204.

The CPU 201 reads a program stored in the memory 202 so as to execute a process defined by the program. The memory 202 stores various programs, data used by the programs, and the like. The interface 203 transmits/receives data to/from the integration management server 10 through the network 11. The interface 204 transmits/receives data to/from the storage systems 30A and 30B through the SW 40A.

The configuration of the host computer 20B is approximately the same as that of the host computer 20A.

The storage system 30A includes a plurality of channel interfaces 310 (310A to 310C), a controller 320 and the disk drives 330.

The channel interfaces 310A to 310C transmit/receive data to/from the host computers 20A and 20B through the SWs 40A and 40B.

The channel interfaces 310A includes a CPU 311, a memory 312, an interface 323, and an interface 324.

The CPU 311 reads a program stored in the memory 312 so as to execute a process defined by the program. The memory 312 stores various programs, data used by the programs, and the like. The interface 313 transmits/receives data to/from the host computer 20A and 20 B through the SW 40A and 40B. The interface 314 transmits/receives data to/from the controller 320 through the controller 320.

Any interface 313 of each of the channel interfaces 310A to 310C is free to transmit/receive data to/from any of host computers 20A and 20B through any of the SW 40A and 40B. In the example shown in FIG. 1, two of the interfaces 313 of the channel interface 310A are connected to the SW 40A. The interfaces 313 of the channel interface 310B (not shown) are connected to the SW 40A. In the same manner, the interfaces 313 of the channel interface 310C (not shown) are connected to the SW 40B. The connections are processed using a port corresponding to a logical interface as a unit.

The controller 320 includes a CPU 321, a memory 322, an interface 323 and a disk interface 324.

The CPU 321 reads a program stored in the memory 322 so as to execute a process defined by the program. The memory 322 stores various programs, data used by the programs, and the like. The interface 323 transmits/receives data to/from the channel interface 310 through the channel interface 310. The disk interface 324 transmits/receives data to/from the disk drive 330 through the disk drive 330.

Each of the disk drives 330 includes at least one hard disk drive 331. The disk drive 330 arranges the hard disk drive 331 in an RAID configuration as an array group. The array group constitutes a logical device corresponding to a logical storage area.

The configuration of the storage system 30B is approximately the same as that of the storage system 30A. In the example shown in FIG. 1, one of the channel interfaces 310 of the storage system 30B is connected to the SW 40A, whereas the other channel interface 310 is connected to the SW 40B.

Hereinafter, the host computers 20A and 20B are collectively denoted as the host computer 20 unless otherwise required. In a similar manner, the storage systems 30A and 30B are collectively denoted as the storage system 30. The SWs 40A and 40B are collectively denoted as the SW 40. The channel interfaces 310A to 310C are collectively denoted as the channel interface 310.

Next, an agent program will be described.

In the embodiment of this invention, each of the host computer 20 and the storage system 30 is provided with a program for obtaining its own performance information. Then, the performance information obtained by a process of the program is collected by a manager program provided for the integration management server 10.

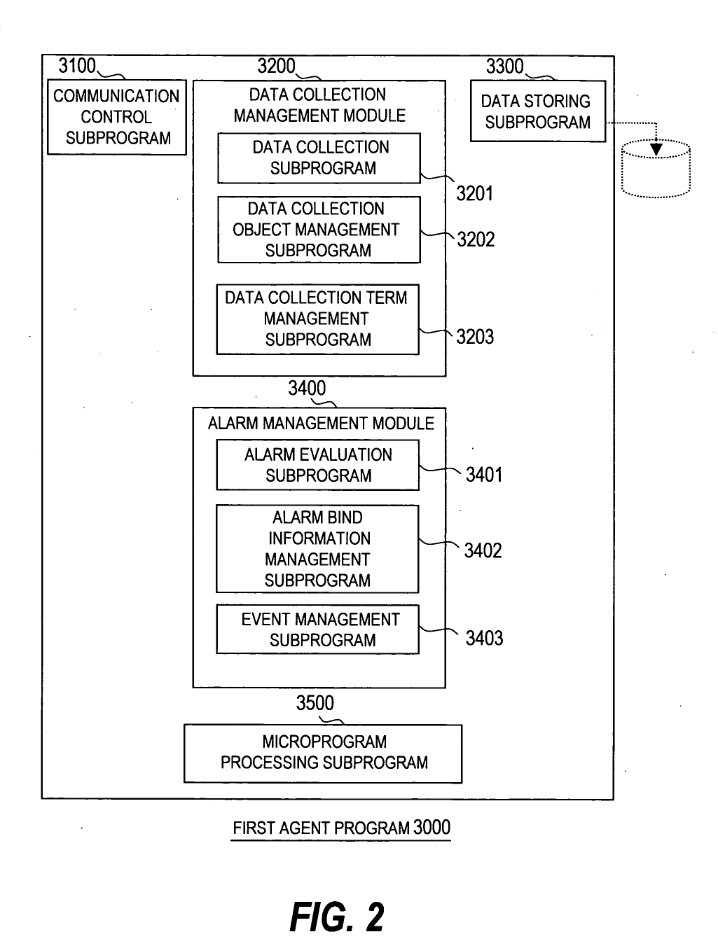

FIG. 2 is a functional block diagram of the first agent program 3000 provided for the storage system 30.

The first agent program 3000 is stored in any of the logical devices of the disk drives 330 of the storage system 30 by a processing of the integration management server 10. The storage system 30 reads out the stored first agent program 3000 so as to set a process of the program executable (hereinafter, the setting is referred to as installation) so as to execute the process of the first agent program 3000. The process permits the performance information of the storage system 30 to be obtained.

The first agent program 3000 includes a communication control subprogram 3100, a data collection management module 3200, a data storing subprogram 3300, an alarm management module 3400, and a microprogram processing subprogram 3500.

The data collection management module 3200 includes a data collection subprogram 3201, a data collection object management subprogram 3202, and a data collection term management subprogram 3203.

The alarm management module 3400 includes an alarm evaluation subprogram 3401, an alarm bind information management subprogram 3402, and an event management subprogram 3403.

The communication control subprogram 3100 performs processings for the communication of the first agent program 3000. More specifically, the communication control subprogram 3100 transmits the performance information obtained by the first agent program 3000 to the integration management server 10 or receives an alarm transmitted from the integration management server 10.

The data collection management module 3200 executes processings for obtaining the performance information of the storage system 30. More specifically, the data collection subprogram 3201 obtains a data collection object set by the data collection object management subprogram 3202, in other words, the performance information of the port or the logical device at data collection intervals set by the data collection term management subprogram 3203.

The data storing subprogram 3300 stores the performance information obtained by the data collection management module 3200 in the logical device of the disk drive 330.

The alarm management module 3400 executes a processing for the alarm. More specifically, the alarm evaluation subprogram 3401 compares alarm information managed by the alarm bind information management subprogram 3402 with the obtained performance information so as to determine whether or not the alarm is to be informed as an event. When the alarm is determined to be informed as an event, the event management subprogram 3403 informs the integration management server 10 of the contents of the alarm as an event.

The microprogram processing subprogram 3500 is provided for the controller 320 of the storage system 30 so as to obtain data regarding the performance information by a program for a processing regarding data input/output to/from the disk drive 330, in other words, data regarding the performance information from a microprogram.

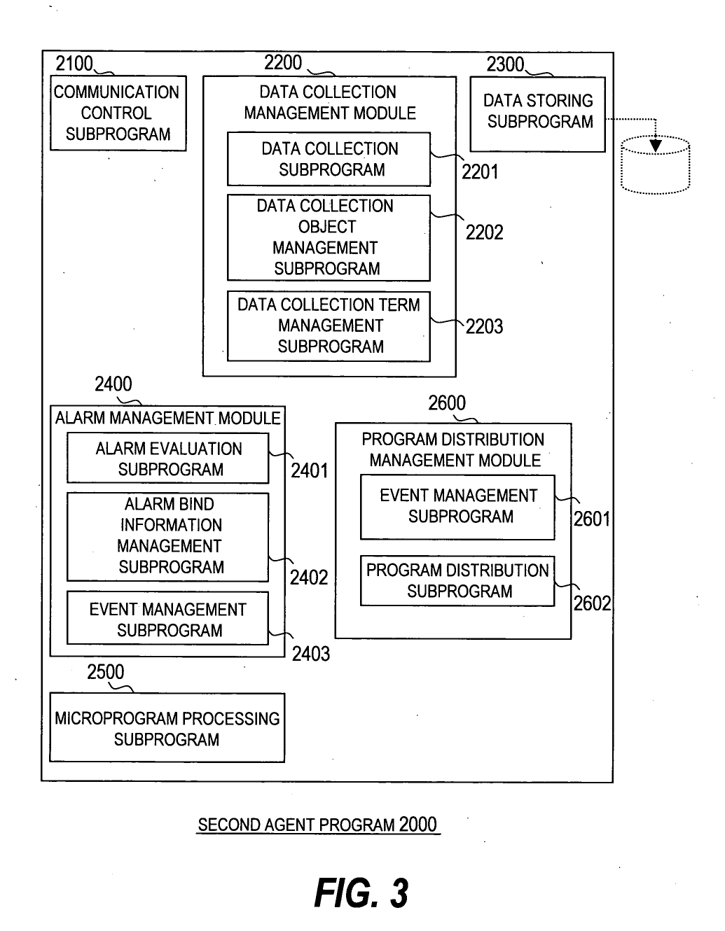

FIG. 3 is a functional block diagram of the second agent program 2000 provided for the host computer 20.

The second agent program 2000 is stored in the host computer 20 by the processing of the integration management server 10. The host computer 20 reads out the stored second agent program 2000 so as to install the program to execute the second agent program 2000. This processing allows the performance information of the host computer 20 (or the SW 40) to be obtained.

The second agent program 2000 includes a communication control subprogram 2100, a data collection management module 2200, a data storing subprogram 2300, an alarm management module 2400, a microprogram processing subprogram 2500, and a program distribution management module 2600.

The data collection management module 2200 includes a data collection subprogram 2201, a data collection object management subprogram 2202, and a data collection term management subprogram 2203.

The alarm management module 2400 includes an alarm evaluation subprogram 2401, an alarm bind information management subprogram 2402, and an event management subprogram 2403.

The program distribution management module 2600 includes an event management subprogram 2601 and a program distribution subprogram 2602.

Since the processings of the communication control subprogram 2100, the data collection management module 2200, the data storing subprogram 2300, the alarm management module 2400, and the microprogram processing subprogram 2500 are approximately the same as those of the first agent program 3000 described above, the description thereof is herein omitted. The microprogram processing subprogram 2500 obtains data regarding performance information from a program for executing a processing regarding data input and output between the host computer 20 and the storage system 30, in other words, a microprogram.

The program distribution management module 2600 manages the distribution of a program, in other words, the first agent program 3000. More specifically, in response to a request for the distribution of the first agent program 3000, which is transmitted from the integration management server 10, the event management program 2601 transmits the received first agent program 3000 to the storage system 30 corresponding to a distribution target through the program distribution subprogram 2602.

At this time, the integration management server 10 transmits a request of distribution of the program as a request command to the host computer 20. The program distribution management module 2600 of the second agent program 2000 of the host computer 20 writes the first agent program 3000 regarding the request and its setting information as write data to the logical device of the storage system 30. Thereafter, the integration management server 10 instructs the storage system 30 to install the written first agent program 3000 through the network 11.

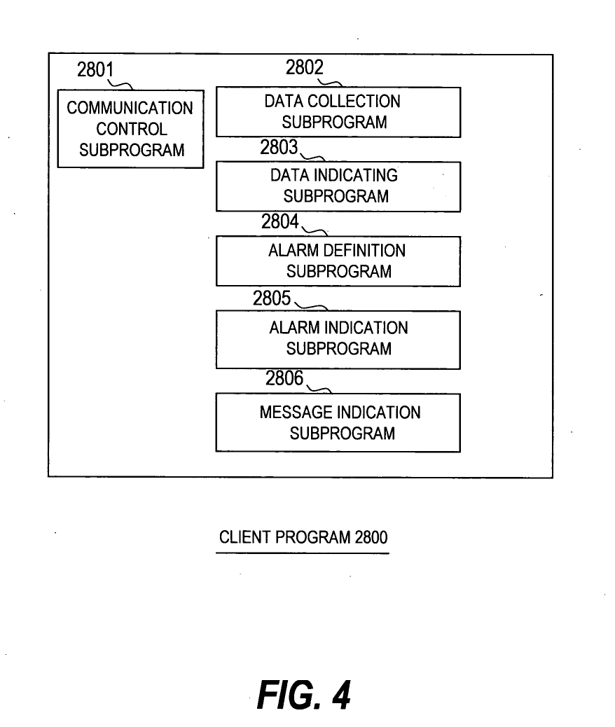

FIG. 4 is a functional block diagram of a client program 2800 provided for the integration management server 10.

The client program 2800 functions as a user interface with an administrator in the integration management server 10. In other words, the client program 2800 notifies the administrator of information or receives the input of information from the administrator.

The client program 2800 includes a communication control subprogram 2801, a data collection management subprogram 2802, a data indicating subprogram 2803, an alarm definition subprogram 2804, an alarm indication subprogram 2805, and a massage indication subprogram 2806.

The communication control subprogram 2801 transmits/receives data to/from another program of the integration management server 10 or the host computer 20 and the storage system 30.

The data collection management subprogram 2802 collects the data through the communication control subprogram 2801. The data indicating subprogram 2803 indicates the performance information collected by the data collection subprogram 2802 on a display device provided for the integration management server 10 or the like.

The alarm definition subprogram 2804 defines a condition to be transmitted to the first agent program 3000 or the second agent program 2000. The alarm indication subprogram 2805 indicates an issued alarm on the display device provided for the integration management server 10. The message indication subprogram 2806 indicates a message to the administrator on the display device provided for the integration management server 10.

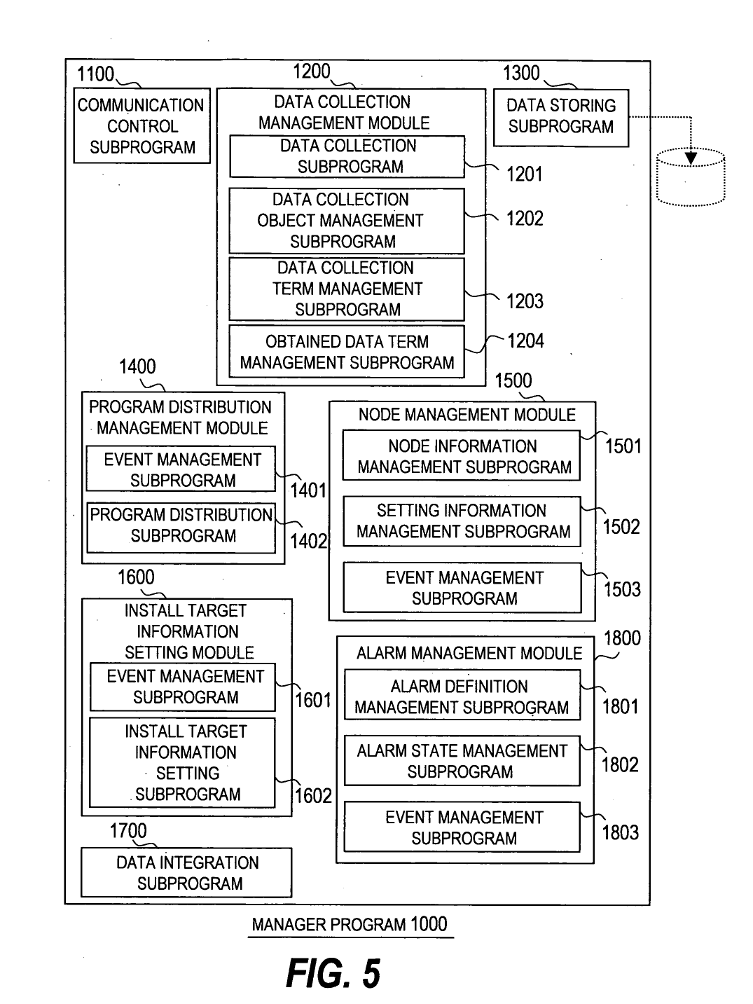

FIG. 5 is a configuration block diagram of a manager program 1000 provided for the integration management server 10.

A manager program 1000 distributes the second agent program 2000 to the host computer 20 while distributing the first agent program 3000 to the storage system 30. Moreover, the manager program 1000 receives the performance information obtained by the first agent program 3000 and the second agent program 2000 to aggregate the received performance information so as to store the aggregate data.

The manager program 1000 includes a communication control subprogram 1100, a data collection management module 1200, a data storing subprogram 1300, a program distribution management module 1400, a node management information module 1500, an install target information setting module 1600, a data integration subprogram 1700, and an alarm management module 1800.

The data collection management module 1200 includes a data collection subprogram 1201, a data collection object management subprogram 1202, a data collection term management subprogram 1203, and an obtained data term processing subprogram 1204.

The program distribution management module 1400 includes an event management subprogram 1401 and a program distribution subprogram 1402.

The node management module 1500 includes a node information management subprogram 1501, a setting information management subprogram 1502, and an event management subprogram 1503.

The install target information setting program 1600 includes an event management subprogram 1601 and an install target information setting subprogram 1602.

The alarm management module 1800 includes an alarm definition management subprogram 1801, an alarm state management subprogram 1802, and an event management subprogram 1803.

The communication control subprogram 1100 performs a processing for the communication of the manager program 1000. More specifically, the communication control subprogram 1100 transmits/receives data to/from the host computer 20 and the storage system 30 through the network 11.

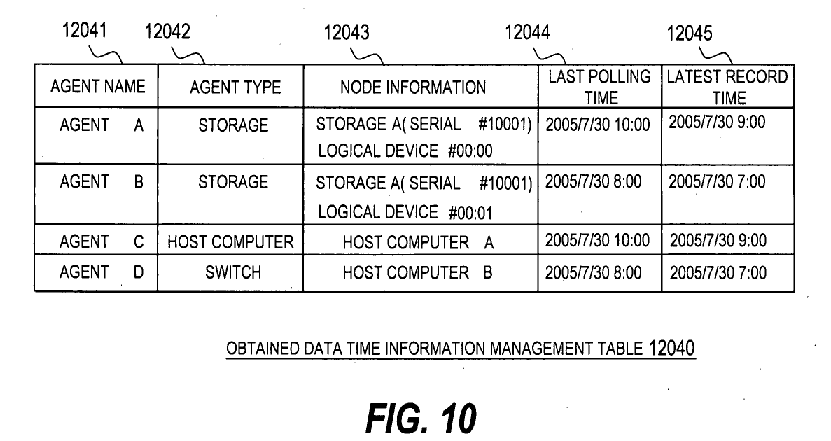

The data collection management module 1200 collects the performance information obtained by the second agent program 2000 and the first agent program 3000 in the host computer 20 and the storage system 30. More specifically, the data collection management subprogram 1201 polls a data collection object set by the data collection object management subprogram 1202, in other words, the performance information obtained by the second agent program 2000 stored in the host computer 20 and the first agent program 3000 stored in the storage system 30 at data collection intervals set by the data collection term management subprogram 1203. As a result of the polling, the data collection subprogram 1201 collects the performance information transmitted from the first agent program 3000 and the second agent program 2000. The obtained data term processing subprogram 1204 manages an obtained data time information management table 12041 shown in FIG. 10, which includes the last polling time and the latest entry time of the performance information obtained from the first agent program 3000 and the second agent program 2000.

The data storing subprogram 1300 stores the performance information collected by the data collection management module 1200 in a memory 122. Alternatively, the integration management server 10 may be provided with a disk device so as to store the performance information. Further alternatively, the performance information may be set so as to be stored in the logical device of the disk drive 330 of the storage system 30.

The program distribution management module 1400 manages the distribution of the programs, in other words, the first agent program 3000 and the second agent program 2000. More specifically, the program distribution subprogram 1402 refers to the information set in the node information management module 1500 so as to request the distribution of the first agent program 3000 and the second agent program 2000. The event management subprogram 1401 transmits the distribution request to the host computer 20 and the storage system 30 as an event.

The node management information module 1500 manages the information of the nodes, in other words, the host computers 20, the storage systems 30 and the SWs 40 constituting the computer system.

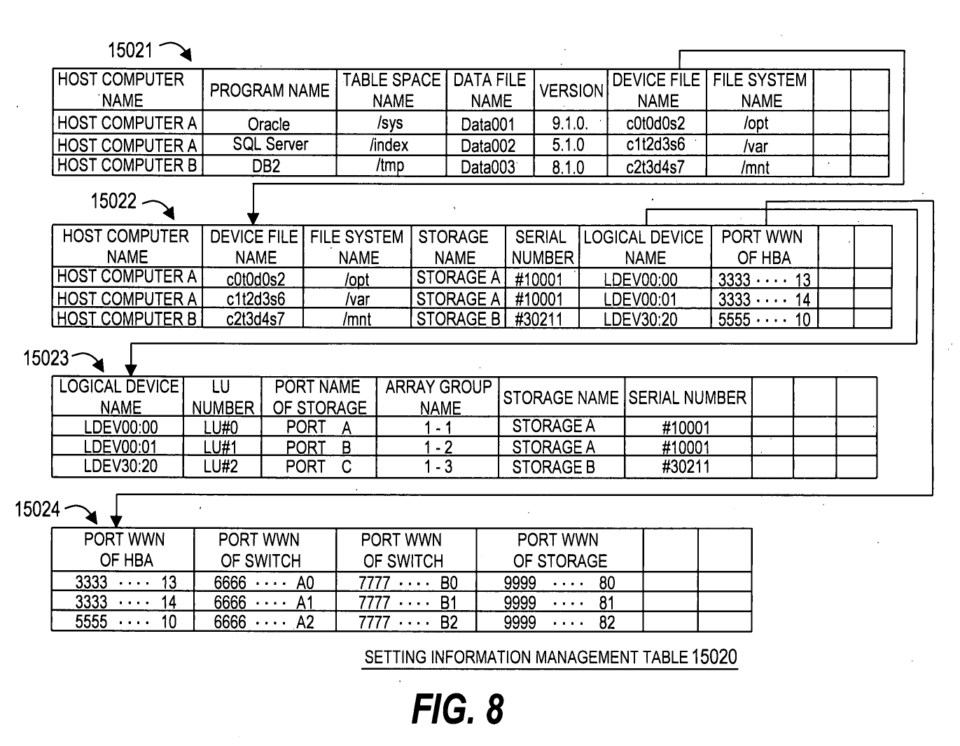

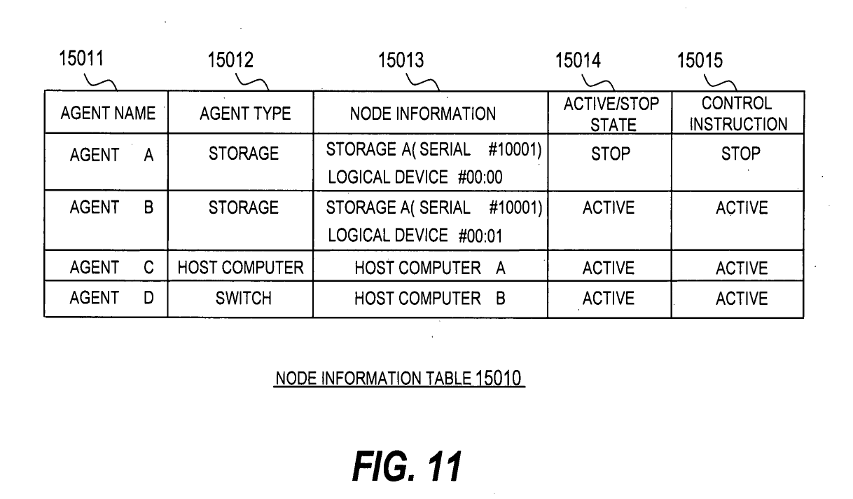

The node information management subprogram 1501 manages the node information table 1501 shown in FIG. 11. The setting information management subprogram 1502 manages a setting information management table 15020 shown in FIG. 8. The event management subprogram 1503 receives an event indicating a modification of the node information or the setting information so as to transmit the information to the node information management subprogram 1501 or the setting information management subprogram 1502.

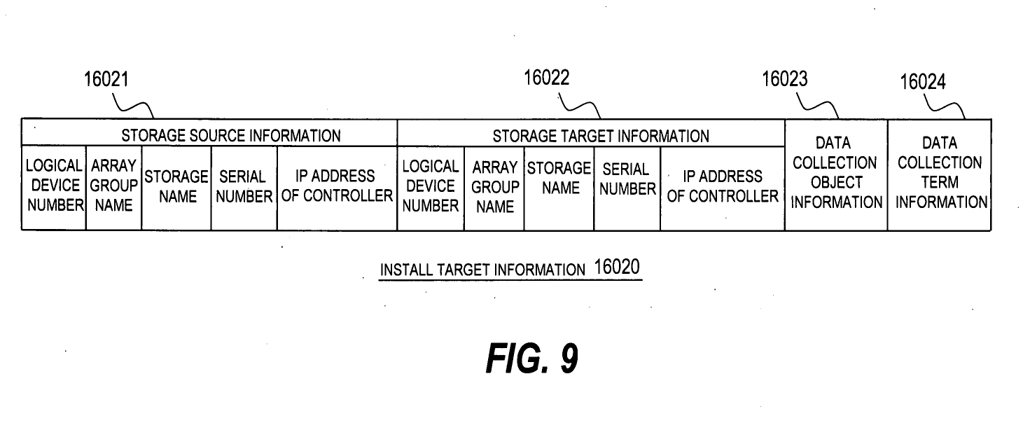

The install target information setting module 1600 manages the installation of the program distributed by the program distribution management module 1500. More specifically, the install target information setting subprogram 1602 refers to the information set in the node information management module 1500 so as to create install target information shown in FIG. 9. The event management subprogram 1601 transmits the thus created install target information to the host computer 20 or the storage system 30 as an event.

The data integration subprogram 1700 receives the performance information obtained by the first agent program 3000 and the second agent program 2000 so as to integrate each of the received data for each of the host computers 20 or the storage systems 30 from which the performance information is obtained.

The alarm management module 1800 transmits an alarm to the host computer 20 and the storage system 30 as an event so as to receive the notification of the alarm from the host computer 20 or the storage system 30. More specifically, the alarm definition management subprogram 1801 transmits an alarm definition created by a client program 2800 to the host computer 20 and the storage system 30. Thereafter, the alarm state management subprogram 1802 receives the alarm notified from the host computer 20 or the storage system 30 so as to update the current alarm state. The event management subprogram 1803 receives the notification of the alarm.

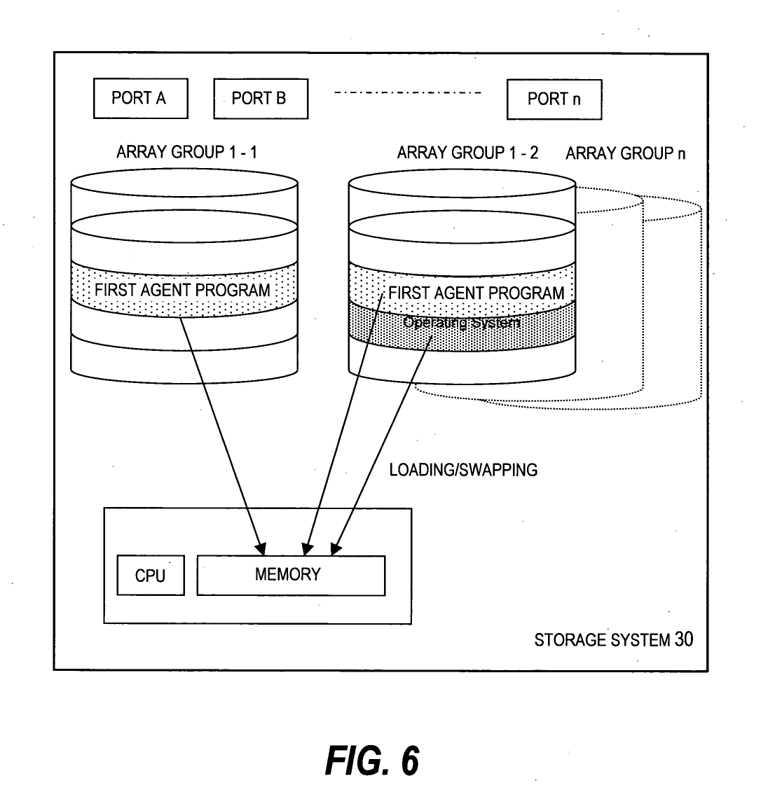

FIG. 6 is an explanatory view of the first agent program 3000 stored in the storage system 30.

As described above, the first agent program 30000 is stored in any of the array group areas of the logical devices of the storage system 30 by the processing of the manager program 1000. Then, in response to a direction from the integration management server 10, the stored first agent program 3000 is installed. More specifically, the first agent program 3000 stored in the array group area is read into a memory 322 of the controller 3200 or the area is swapped so that the processing of the first agent program 3000 is set executable by a CPU 321.

In the storage system 30, an application in the host computer 20 is operated using the logical device corresponding to a storage area of the disk drive 330 as a storage area for the host computer 20. Therefore, when the first agent program 3000 is stored in the logical device frequently accessed by the host computer 20, in other words, the logical device with a higher load, the load affects the obtainment of the performance information by the first agent program 3000.

Therefore, it is desirable to store the first agent program 3000 in the logical device with a load as low as possible so as to obtain the performance information. Accordingly, in the embodiment of this invention, there is provided a mechanism capable of changing a storage location of the first agent program 3000 based on the performance information obtained by the first agent program 3000, in other words, the performance information of the logical device of the disk drive 330.

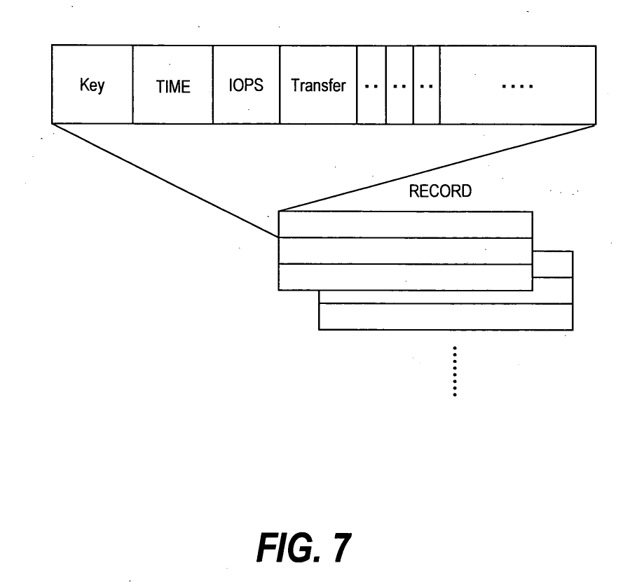

FIG. 7 is an explanatory view of an example of a data format of the performance information transmitted by the first agent program 3000 of the storage system 30 through the host computer 20 to the integration management server 10.

The first agent program 3000 obtains the performance information of the storage system at predetermined intervals or a predetermined time. The performance information contains, for example, an IOPS (I/O Per Second) or a Transfer (the number of bytes of the I/O).

The first agent program 3000 transmits the performance information in the data format shown in FIG. 7 through the second agent program 2000 in the host computer 20 to the integration management server 10. At this time, the first agent program 3000 sets a “Key” for each of the data to be transmitted. The Key serves as a unique identifier for the storage system 30 in the computer system. The setting of the Key allows the performance information data for each of the storage system 30 transmitted in an asynchronous manner to be collected as data of the same storage system 30.

FIG. 8 is an explanatory view of an example of the setting information management table 15020.

The setting information management table 15020 corresponds to logical setting information of each of the structures (the host computer 20, the storage system 30, the SW 40, and the like) included in the computer system, which is managed by the setting information management subprogram 1502.

The setting information management table 15020 contains user program information 15021 regarding the user program operating on the host computer 20, host computer configuration information 15022 regarding the configuration of the host computer 20, storage system configuration information 15023 regarding the configuration of the storage system 30, and SW configuration information 15024 regarding the SW 4.

FIG. 8 shows an example where the correlations are indicated by a GUI. In other words, the data indicating subprogram 2803 of the client program 2800 obtains node information managed by the node information management subprogram 1501 so as to indicate the obtained node information on a display device of the integration management server 10 or the like. At this time, the correlation between them can be indicated so as to allow the correlation of a certain structure with the other structures to be indicated for the administrator in a clearly understandable manner.

In the example shown in FIG. 8, a logical device name of the storage system 30 corresponding to the device file name used by the user program is indicated. Moreover, the array group of the storage system 30 included in the logical device name used by the host computer 20 is also indicated. Furthermore, the port of the SW 40 corresponding to a WWN of the port of an HBA used by the host computer 20 is also indicated.

FIG. 9 is an explanatory view of an example of install target information 16020 of the integration management server 10.

When the manager program 1000 distributes the first agent program 3000 to the storage system 30, the manager program 1000 transmits the install target information 16020 corresponding to program storage target information. The storage system 30 refers to the install target information 16020 to store the first agent program 3000.

The install target information 16020 includes storage source information 16021, storage target information 16022, data collection object information 16023, and data collection term information 16024.

Each of the storage source information 16021 and the storage target information 16022 contains a logical device number, an array group name, a storage system name, a serial number, and an IP address of the controller. As described below, the storage source information 16021 is used for copying the first agent program 3000 already stored in the storage system 30 to another storage target. Therefore, when the manager program 1000 stores the first agent program 3000 in the storage system 30 for the first time, the storage source information 16021 is left blank.

FIG. 10 is an explanatory view of an example of an obtained data time information management table 12040 of the integration management server 10.

The obtained data time information management table 12040 is managed by the obtained data term processing subprogram 1204 of the agent program 1000, and is used to collect the performance information from the first agent program 3000 and the second agent program 2000 by polling. More specifically, the agent program 1000 refers to the contents of the obtained data time information management table 12040 to obtain information indicating the data collection time, the agent program of the node from which the data is collected, and the validity of the already collected data.

FIG. 11 is an explanatory view of an example of a node information table 15010 managed by the manager program 1000.

In the integration management server 10, the node information management subprogram 1501 of the node information management module 1500 of the manager program 1000 manages the node information table 15010.

The node information table 15010 manages the node (the host computer 20, the storage system 30, and the SW 40) at which the agent program (the first agent program 3000 and the second agent program 2000) is stored and the state of the agent program.

The node information table 15010 comprises entries including an agent name 15011, an agent type 15012, node information 15013, an active/stop state 15014, and a control direction 15015.

The agent name 15011 stores an identifier of the agent program. The agent type 15012 stores the type of the node of the agent program. The node information 15013 stores information of the node storing the agent program. The active/stop state 15014 stores the current state of the agent program. The control direction 15015 stores a state of the control direction to the agent program.

For example, for the entry having “Agent A” as the agent name 15011, the agent type 15012 is indicated as “Storage”. Its node information 15013 is stored in “Logical device #10:00 of Storage A (Serial #1001)”. The control direction 15015 to the agent program is “Stop”. According to the control direction, “Stop” is indicated as the active/stop state 15014.

Next, an operation of the computer system having the configuration as described above according to this embodiment of this invention will be described.

First, the distribution of the agent program will be described.

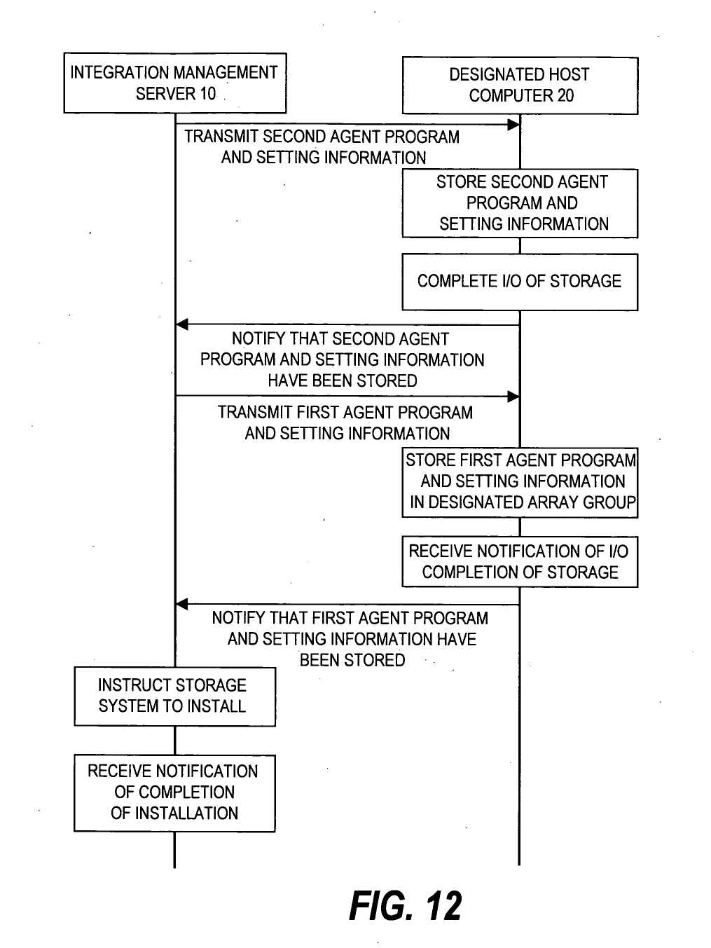

FIG. 12 is a sequence diagram of a processing of distributing the first agent program 3000 and the second agent program 2000 by the manager program 1000 of the integration management server 10.

In the integration management server 10, the program distribution management module 1400 of the manager program 1000 first transmits the second agent program 2000 to the host computer 20 designated by the administrator. At the same time, the program distribution management module 1400 transmits setting information necessary for the processing to be executed by the second agent program 2000. Moreover, the host computer 20 installs and executes the received second agent program 2000.

The host computer 20 receiving the second agent program 2000 and the setting information stores the received second agent program 2000 and setting information in the memory 202. Upon completion of the storage, the host computer 20 transmits a notification indicating the completion of the storage of the second agent program 2000 and the setting information to the integration management server 10 corresponding to a transmission source.

The manager program 1000, which receives the notification, transmits the first agent program 3000 to the host computer 20. At the same time, the manager program 1000 transmits setting information necessary for the processing to be executed by the first agent program 3000, in particular, information regarding the storage system 30 corresponding to a storage target.

The first agent program 3000 and the setting information are received by the second agent program 2000 of the host computer 20. Based on the received setting information, the program distribution management module 2600 of the second agent program 2000 determines the logical device of the storage system 30 into which the first agent program 3000 and the setting information are to be stored. Then, the first agent program 3000 and the setting information are stored in the determined storage location.

Upon reception of the completion of the I/O of the storage of the first agent program 3000 and the setting information from the storage system 30, the program distribution management module 2600 transmits a notification indicating the completion of the storage of the first agent program 3000 and the setting information to the integration management server 10. At the same time, the information of the determined storage target is transmitted.

The manager program 1000, which receives the notification, indicates the information of the logical device contained in the received storage target information to the storage system 30 corresponding to the storage target so as to instruct the installation of the first agent program 3000.

Thereafter, upon reception of the notification of the completion of the installation of the first agent program 3000 from the storage system 30, the manager program 1000 terminates the processing of this sequence.

By the processing of the first agent program 3000 stored by the processing shown in FIG. 9, the performance information of the storage system 30 is obtained. Moreover, by the processing of the second agent program 2000, the performance information of the host computer 20 is obtained. The performance information obtained by the first agent program 3000 is transmitted to the second agent program 2000 of the host computer 20 in a periodic manner, at a predetermined time, or in response to a request of the second agent program 2000 of the host computer 20. The second agent program 2000 of the host computer 20 transmits the transmitted performance information together with the performance information obtained by itself. The manager program 1000 of the integration management server 10 collects the transmitted performance information.

Next, a processing of changing the storage location of the first agent program 3000 based on the collected performance information will be described.

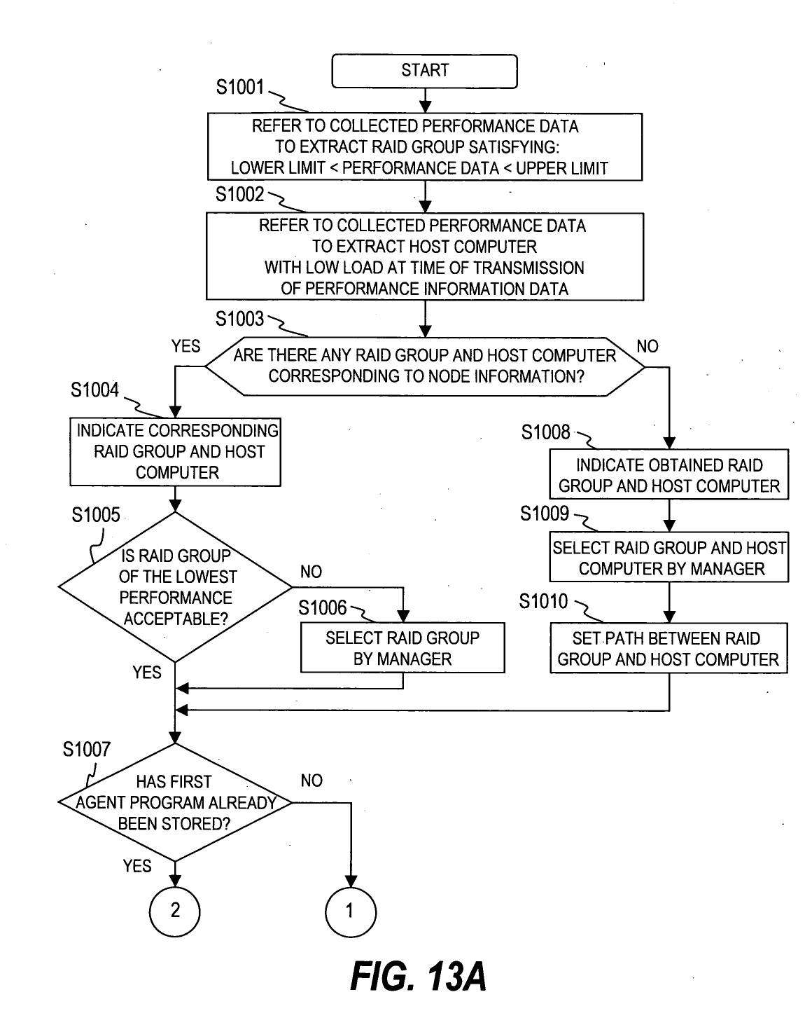

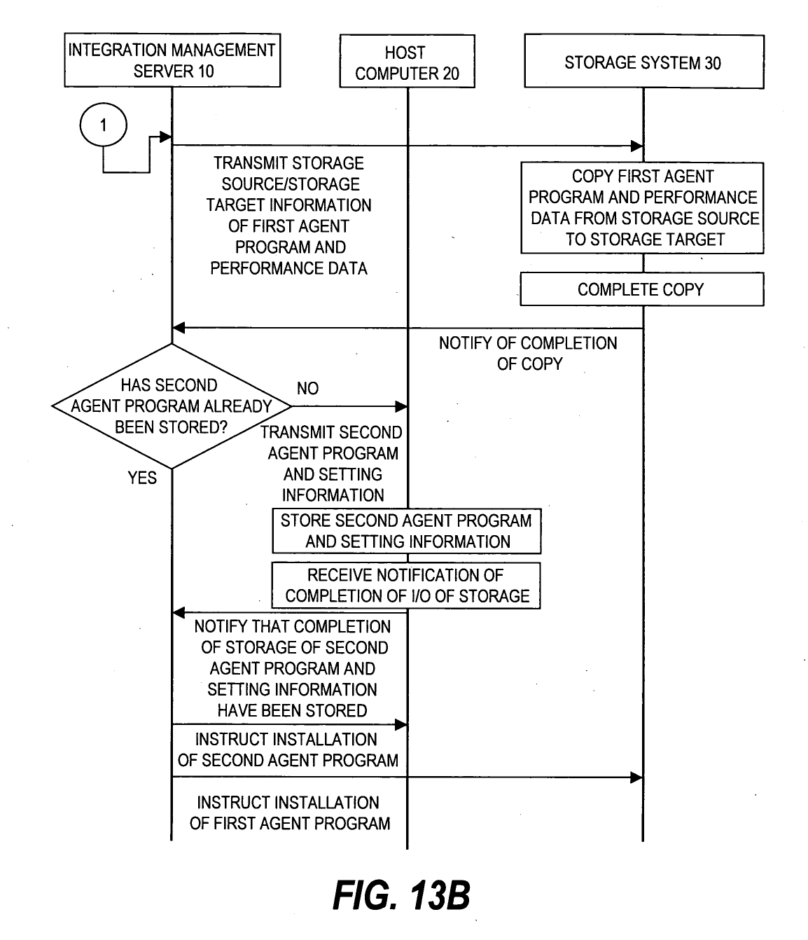

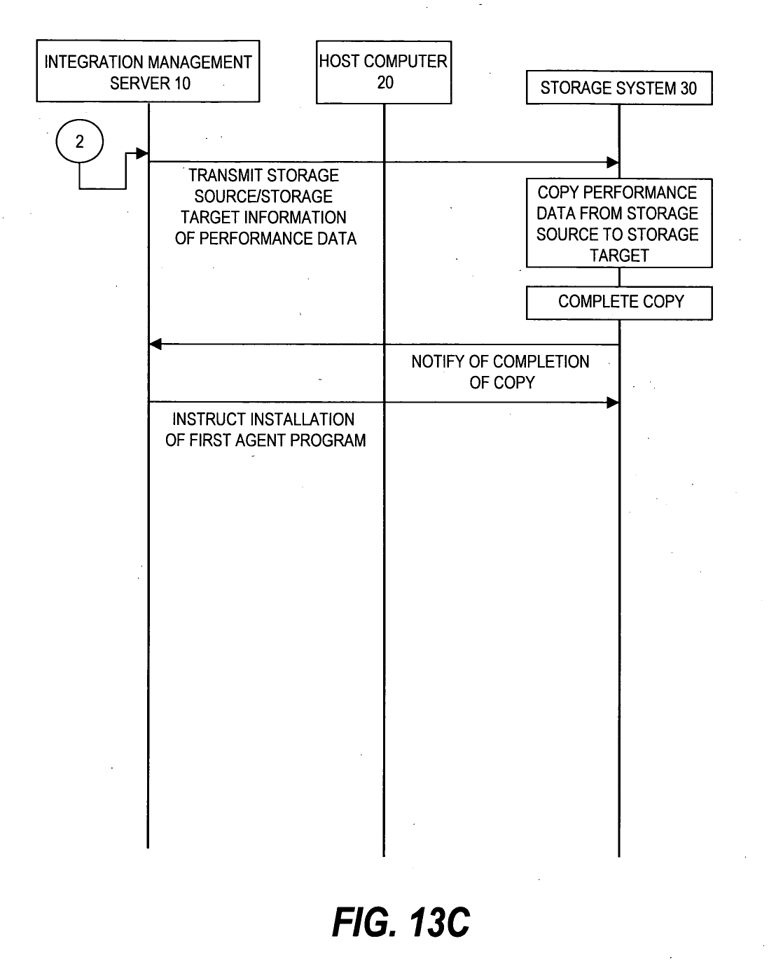

FIGS. 13A to 13C are a flowchart and sequence diagrams of the processing for changing the storage location of the first agent program 3000 by the client program 2800.

In FIG. 13A, the data collection subprogram 2802 of the client program 2800 refers to the performance information collected by the manager program 1000. Then, the data collection subprogram 2802 extracts an array group name corresponding to the logical device name of data of performance information which is larger than a preset lower limit and smaller than a preset upper limit. The data of the performance information may be an IOPS for the array group or the transfer data amount (step S1001).

Next, the data collection subprogram 2802 refers to the collected performance information so as to extract a name of the host computer 20 having a lower load than a preset load at a time for transmitting the performance information data from the first agent program 3000 to the second agent program 2000 (step S1002).

In the steps S1001 and S1002, threshold values (an upper limit, a lower limit and a load value) are preset. When there are any array group and host computer exceeding the threshold value, the corresponding array group and host computer are extracted. On the other hand, the integration management server 10 may notify of a threshold value set by the administrator as alarm information so that the array group and the host computer are extracted depending on the presence or the absence of the alarm notification returned when the alarm condition is satisfied. The notification of the alarm will be described below.

Next, the data collection subprogram 2802 refers to the node information shown in FIG. 11 from the node information management module 1500 of the manager program 1000. Then, the data collection subprogram 2802 determines whether or not there are the array group name extracted in the step S1001 and the host name extracted in the step S1002 corresponding to the referred node information (step S1003). In other words, it is determined whether or not the array group name corresponding to the logical device name used by the host computer 20 extracted in the step S1002 contains the array group extracted in the step S1001.

When it is determined that there are corresponding ones, the processing proceeds to a step S1004. On the other hand, when it is determined there is no corresponding one, the processing proceeds to a step S1008.

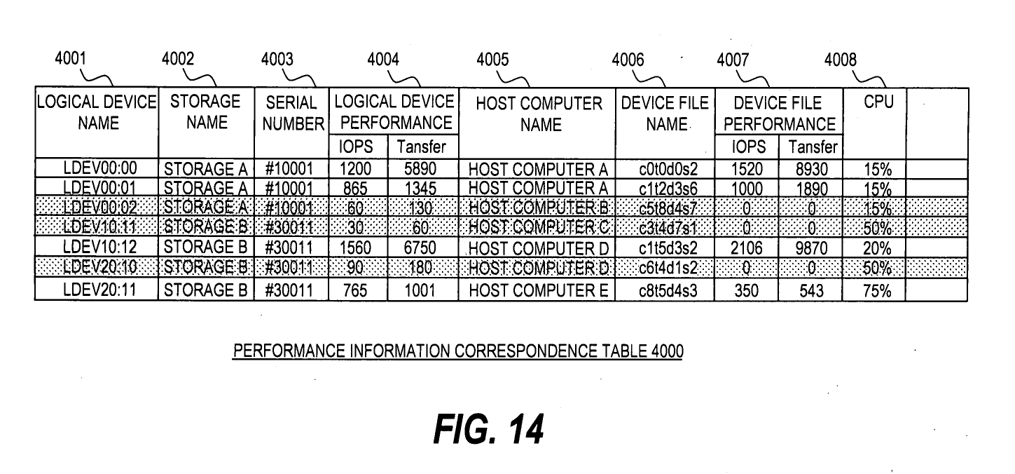

In the step S1004, the administrator is notified of performance information having the correlation with the array group and the host computer 20 among the collected performance information as a performance information correspondence table shown in FIG. 14. Specifically, the performance information correspondence table is indicated on a display device of the integration management server 10 or the like. Furthermore, the administrator is notified of the performance information correspondence table in an easily understood manner by coloring the performance information having the correlation.

Upon reception of the notification, the administrator selects the array group to which the first agent program 3000 is to be moved.

In other words, it is determined whether or not the selection of the array group having the lowest performance among the notified array groups is acceptable (step S1005). The array group having the lowest performance means the array group having the lowest frequency of use in the storage system 30. Therefore, if the first agent program 3000 is stored in the array group with the lowest performance, the effect of the I/O to/from the array group on the performance information becomes the lowest when the performance information is to be obtained.

Alternatively, the administrator may refer to the notified performance information to select the array group in which the first agent program 3000 is to be stored (step S1006).

On the other hand, when it is determined in the step S1003 that there is no corresponding one, the processing proceeds to a step S1008 where the administrator is notified of the performance information containing the array group extracted in the step S1001 and the host computer extracted in the step S1002.

Based on the performance information, the administrator determines the array group, in which the first agent program 3000 is to be stored, and the host computer 20 using the array group (step S1009). At this time, a path from the host computer 20 is not set to the array group, a path between the array group and the host computer 20 is assigned so as to set the array group usable by the host computer 20 (step S1010).

Next, the client program 2800 determines whether or not the first agent program 3000 is already stored in the array group selected in the step S1005, S1006 or S1009 (step S1007).

The case where the first agent program 3000 is already stored corresponds to, for example, the case where the array group and the host computer 20 are not modified or the case where the first agent program 3000 was stored in the array group once before.

When the first agent program 3000 is not stored yet, the processing proceeds to FIG. 13B.

In FIG. 13B, the client program 2800 of the integration management server 10 passes the processing to the manager program 1000. The manager program 1000 first transmits the first agent program 3000 and the information of the array group (hereinafter, referred to as storage source information), in which the performance information obtained by the first agent program 3000 is stored, and the information of the array group selected in the step S1005, S1006 or S1009 (hereinafter, referred to as storage target information) to the storage system 30.

In the storage system 30, the controller 320 refers to the received storage source information and storage target information so as to copy the first agent program 3000 and the performance information stored in the storage source array group to the storage target array group. Upon completion of the copy, the controller 320 transmits a notification of the completion of the copy to the integration management server 10.

In the integration management server 10, the manager program 1000 next determines whether or not the second agent program 2000 is already stored in the host computer 20. When the second agent program 2000 is not stored, the manager program 1000 transmits the second agent program 2000 and the setting information to the host computer 20.

The host computer 20 receiving the second agent program 2000 and the setting information stores the received second agent program 2000 and setting information in the memory 202. Upon completion of the storage, the host computer 20 transmits a notification indicating the completion of the storage of the second agent program 2000 and the setting information to the integration management server 10 corresponding to a transmission source.

When the second agent program 2000 is already stored in the host computer 20 and the notification indicating the completion of the storage from the host computer 20 is received, the manager program 1000 first instructs the host computer 20 to install the second agent program 2000. Next, the manager program 1000 instructs the storage system 30 to install the first agent program 3000.

When the installation of the first agent program 3000 and the second agent program 2000 is completed, the performance information is obtained by the processings of the programs. Then, the performance information is collected by the integration management server.

On the other hand, when the first agent program 3000 is already stored in the step S1007 (FIG. 13A), the processing proceeds to FIG. 13C.

In FIG. 13C, the client program 2800 of the integration management server 10 passes the processing to the manager program 1000. The manager program 1000 transmits the storage source information corresponding to the information of the array group storing the performance information obtained by the first agent program 3000 and the storage target information to the storage system 30.

In the storage system 30, the controller 320 refers to the received storage source information and storage target information so as to copy the performance information stored in the array group corresponding to the storage source to the array group corresponding to the storage target. Upon completion of the copy, the controller 320 transmits a notification of the completion of the copy to the integration management server 10.

When the notification of the completion of the copy from the storage system 30 is received, the manager program 1000 instructs the storage system 30 to install the first agent program 3000.

Upon completion of the installation of the first agent program 3000, the performance information is obtained by the processings of the programs and then is collected by the integration management server 10.

FIG. 14 is an explanatory view of an example of the performance information correspondence table displayed in the step S1004 in FIG. 13A.

The performance information correspondence table 4000 contains an entry indicating a correlation between a logical device name 4001 and a host computer name 4005 set to be able to use the logical device. An entry with the performance of the logical device larger than a lower limit and smaller than an upper limit and the host computer having a low load is shaded.

Each of the entries contains the logical device name 4001, a storage device name 4002 including the logical device, a storage serial number 4003, a logical device performance of the logical device 4004, a host computer name 4005, a device file name 4006 corresponding to the host computer, a device file performance of the device file 4007, and a CPU load 4008.

The administrator refers to the performance information correspondence table 4000 notified by the integration management server 10 to determine the logical area in which the first agent program 3000 is to be stored.

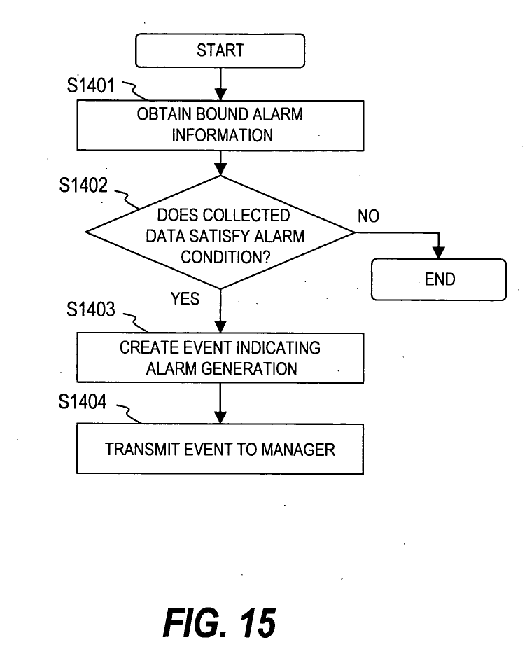

FIG. 15 is a flowchart of an alarm notification.

In the first agent program 3000 and the second agent program 2000, when the collected performance information satisfies a condition of alarm information based on the alarm information transmitted from the manager program 1000 as an event, the alarm management modules (3400 and 2400) notifies the manager program 1000 of the collected performance information as an alarm.

Although the processing is described as that of the alarm management module 3400 of the first agent program 300, the processing of the alarm management module 2400 of the second agent program 2000 is the same.

First, in the alarm management module 3400, the alarm bind information management subprogram 3402 obtains alarm information when the alarm information is contained in the event notified from the manager program 1000 (step S1401).

Next, the alarm evaluation subprogram 3401 compares the performance information obtained by the data collection management module 3200 and the alarm condition contained in the obtained alarm information so as to determine whether or not the performance information satisfies the alarm condition (step S1402).

When the performance information does not satisfy the alarm condition, the processing is terminated.

On the other hand, when the performance information satisfies the alarm condition, the event management subprogram 3403 creates an event indicating the generation of the alarm corresponding to the alarm condition (step S1403). Then, the event management subprogram 3403 transmits the generated event to the manager program 1000.

By the above processing, the manager program 1000 is notified of the generation of the alarm.

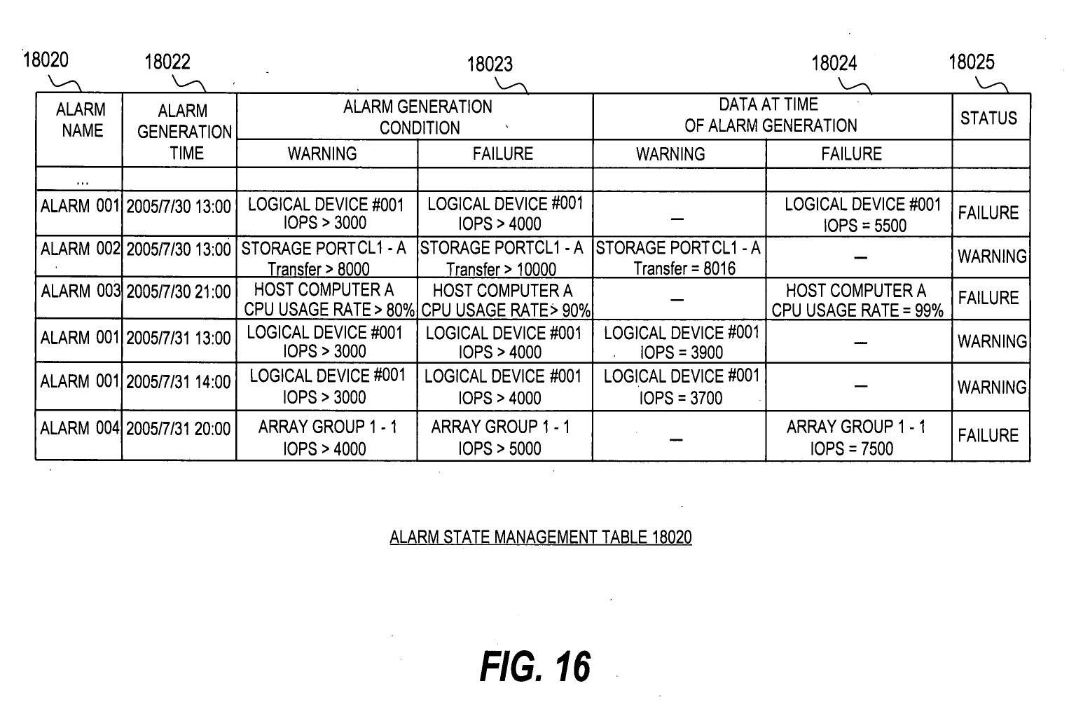

FIG. 16 is an explanatory view of an example of an alarm state management table 18020 managed by the alarm management module 1800 of the manager program 1000.

The alarm state management table 18020 is managed by the alarm management module 1800 of the manager program 1000.

The alarm generation event transmitted by the first agent program 3000 and the second agent program 2000 is received by the event management subprogram 1803 of the alarm management module 1800 of the manager program 1000. Then, the contents of the alarm generation event are stored in the alarm state management table 18020 by the alarm state management subprogram 1802.

The alarm state management table 18020 contains an alarm name 18021, an alarm generation time 18022, an alarm generation condition 18023, data at the time of generation of the alarm 18024, and a status 18025.

The alarm name 18021 stores an identifier attached to each of the received alarms. The alarm generation time 18022 stores information of the time at which the alarm is generated. The alarm generation condition 18023 stores an alarm generation condition set by the administrator. The data at the time of generation of the alarm 18024 stores information of the performance information obtained by the agent program at the time when the alarm is generated. The status 18025 stores the contents of the alarm.

For example, for the entry with “Alarm 001” as the alarm name 18021, it is indicated that the alarm is generated at the time indicated by the alarm generation time 18022, “2005 Jul. 30, 13:00”. The alarm generation condition 18023 is a warning when the IOPS of the logical device #001 exceeds 3000 and is a failure when the IOPS exceeds 4000. For the data at the time of generation of the alarm 18024, the IOPS is 5500. Therefore, “Failure” is set in the status 18025.

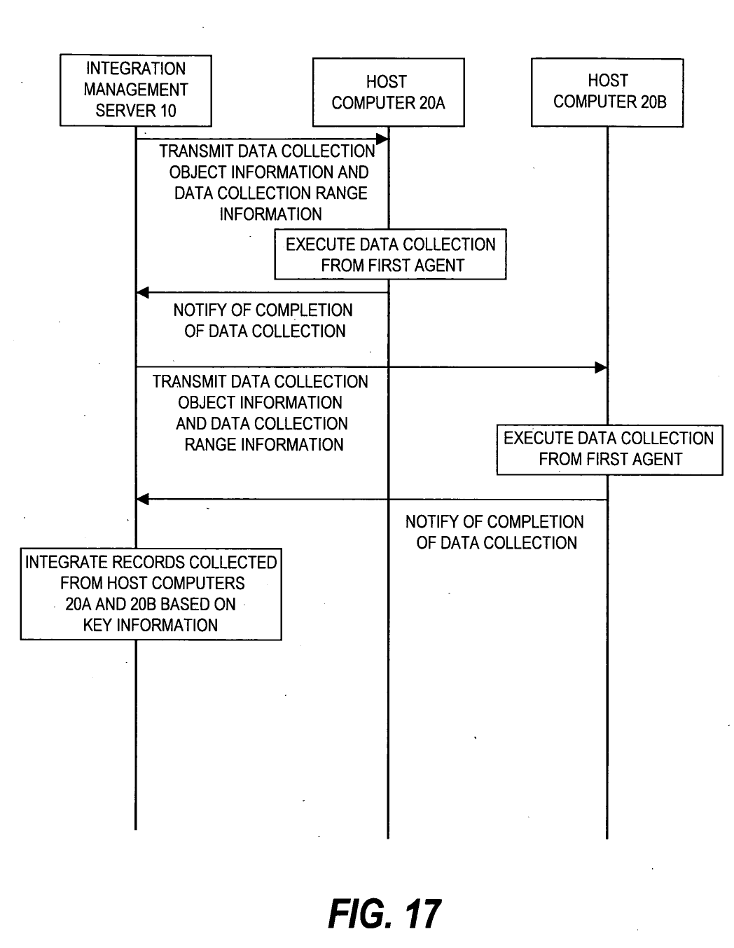

FIG. 17 is a sequence diagram of a processing in which the integration management server 10 collects the data.

In the computer system according to this embodiment, the performance information obtained by the first agent program 3000 of the storage system 30 is temporarily transmitted to the second agent program 2000 of the host computer 20. The second agent program 2000 transmits the received performance information to the integration management server 10. At this time, the first agent program 3000 transmits the performance information to the plurality of host computers 20, in other words, the host computers 20A and 20B in a distributed manner.

First, in the integration management server 10, the data collection management module 1200 of the manager program 1000 transmits data collection object information and data collection range information to the second agent program 2000 of the host computer 20A.

In the host computer 20A, the data collection management module 2200 of the second agent program 2000 makes a request to the storage system 30 corresponding to a data collection object for the transmission of the obtained performance information in accordance with the received data collection object information and data collection range information. Then, the data collection management module 2200 transmits the received performance information to the integration management server 10.

Similarly, the data collection management module 1200 of the manager program 1000 transmits data collection object information and data collection range information to the second agent program 2000 of the host computer 20B.

In the host computer 20B, the data collection management module 2200 of the second agent program 2000 makes a request to the storage system 30 corresponding to a data collection object for the transmission of the obtained performance information in accordance with the received data collection object information and data collection range information. Then, the data collection management module 2200 transmits the received performance information to the integration management server 10.

The manager program 1000 refers to the Keys attached to the performance information to arrange the performance information received from the second agent program 2000 in the host computer 20A and the second agent program 2000 in the host computer 20B in order of time.

The data collection range information contains a direction that allows the different host computer 20 to receive the performance information at each time. More specifically, for example, the performance information obtained from 0:00 to 7:59 is received by the host computer 20A, whereas the performance information obtained from 8:00 to 12:59 is received by the host computer 20B. In this manner, the performance information is collected by the plurality of host computers in a distributed manner, thereby preventing a load on the particular host computer 20 from being increased.

The data collection range information may be distributed not by switching the host computer 20 that receives the information for each time but for each port of the storage system 30, in other words, the path set between the storage system 30 and the host computer 20. Alternatively, the host computers 20 may be allocated to the respective logical devices set in the storage system 30.

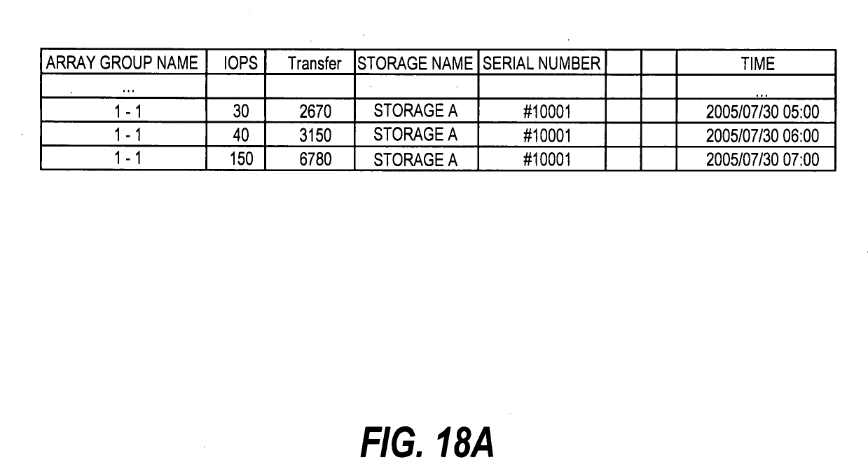

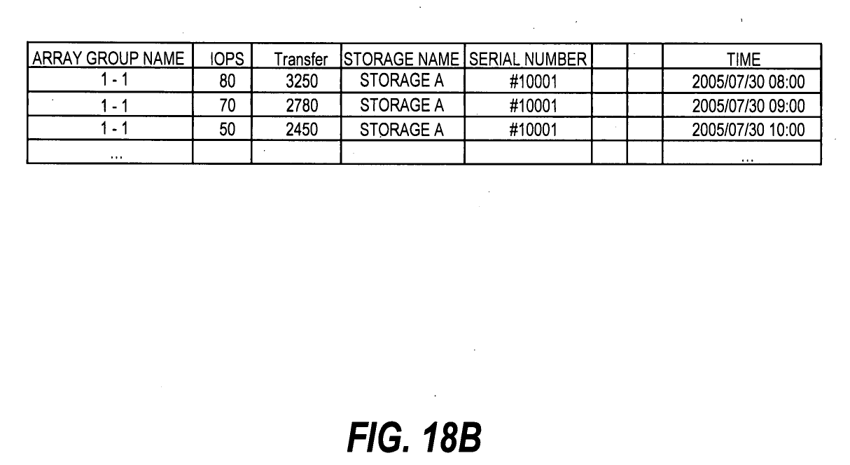

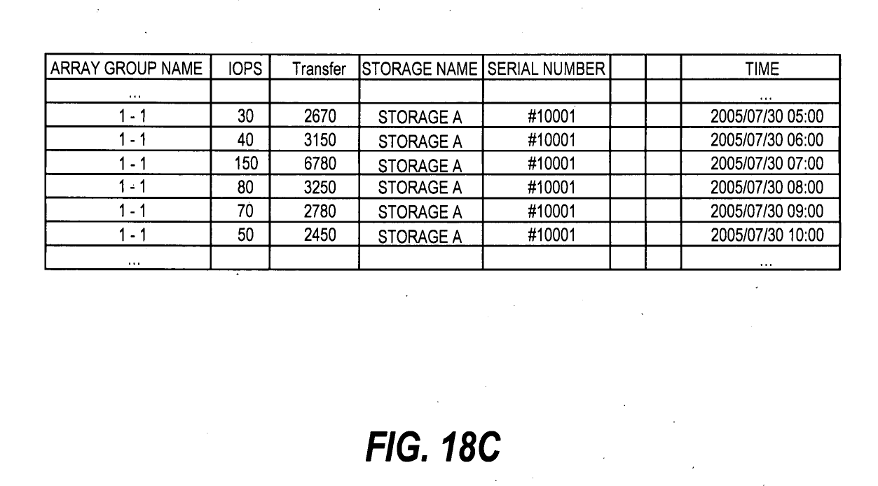

FIG. 18 is an explanatory view of the distribution of the performance information obtained by the storage system 30.

The first agent program 3000 in the storage system 30 stores the obtained performance information as a database in order of obtainment time as shown in FIG. 18C.

The case where the data collection range information is set so that the performance information obtained from 0:00 to 7:59 is collected by the second agent program 2000 of the host computer 20A and the performance information obtained from 8:00 to 12:59 is collected by the second agent program 2000 of the host computer 20B will be considered. The second agent program 2000 makes a request to the first agent program 3000 in the storage system 30 for the transmission of the performance information obtained from 0:00 to 7:59. In response to this request, the first agent program 3000 transmits the performance information obtained during the requested time period, in other word, FIG. 18A, to the host computer 20A. At this time, the performance information is transmitted with the Key corresponding to identification information indicating the storage system 30 being attached to header information of the data to be transmitted.

Similarly, the second agent program 2000 of the host computer 20B makes a request to the first agent program 3000 in the storage system 30 for the transmission of the performance information obtained from 8:00 to 12:59. In response to this request, the first agent program 3000 transmits the performance information obtained during the requested time period, in other word, FIG. 18B, to the host computer 20B. At this time, the performance information is transmitted with the Key corresponding to identification information indicating the storage system 30 being attached to header information of the data to be transmitted.

Each of the second agent program 2000 of the host computer 20A and the second agent program 2000 of the host computer 20B transmits the collected performance information to the integration management server 10.

In the integration management server 10, the data integration subprogram 1700 of the manager program 1000 receives the performance information.

The data integration subprogram 1700 refers to the header information in the performance information transmitted from each of the host computers 20 to group the performance information with the same Key in time series as single performance information. The format of the performance information is the same as that obtained by the storage system 30, in other words, FIG. 18C. The data integration subprogram 1700 stores the performance information in the memory 102.

In the computer system having the above configuration according to the embodiment of this invention, the first agent program 3000 for obtaining the performance information of the storage system 30 is stored in the storage system 30. Therefore, the effects of the transmission and reception of data on the network on the performance information can be minimized.

Moreover, since the performance information obtained by the first agent program 3000 is distributed and then collected by the plurality of host computers 20 so as to be transmitted to the integration management server 10, a load on the particular host computer 20 or a particular path set between the host computer 20 and the storage system 30 can be reduced.

Moreover, since the first agent program 3000 stored in the storage system 30 is stored in the logical device whose path is set to the host computer with a lower load among the logical devices of the storage system 30 with a low load, more precise performance information can be collected while being hardly affected by the other processings. At the same time, the effects on the applications operated by the host computer 20 and the storage system 30 can be minimized.

While the present invention has been described in detail and pictorially in the accompanying drawings, the present invention is not limited to such detail but covers various obvious modifications and equivalent arrangements, which fall within the purview of the appended claims.

What is claimed is:

1. A performance information collecting method executed in a computer system comprising:
a disk drive, in which at least one logical area that stores data is set;
a storage system comprising a control unit that controls read and write of data from and to the disk drive and an interface connected to a host computer;
the host computer connected to the interface through a network, the host computer making a request of read and write of data from and to the logical area of the disk drive; and
a management computer that collects performance information of the storage system, the network, and the host computer,
wherein a correlation between the host computer and the logical area used by the host computer is set, and
the performance information collecting method comprises:
a first step of obtaining, by the control unit, the performance information of the storage system;
a second step of transmitting, by the control unit, the obtained performance information to the host computer having a lower load than a predetermined threshold value;
a third step of transmitting, by the host computer, the performance information transmitted from the control unit to the management computer; and
a fourth step of collecting, by the management computer, the transmitted performance information.

2. The performance information collecting method according to claim 1, wherein the control unit stores a program that obtains the performance information, and, in the first step, the control unit stores the program in the logical area having a lower load than the threshold value and obtains the performance information by a processing of the stored program.

3. The performance information collecting method according to claim 2, comprising a plurality of the host computers,
wherein the second step comprises the substeps of: dividing, by the control unit, the performance information obtained by the program into at least two data; adding, by the control unit, information that identifies the storage system to the divided data; and transmitting, by the control unit, the data, to which the identifier is added, to at least two of the host computers in a distributed manner,
wherein each of the host computers transmits the data transmitted by the control unit to the management computer in the third step, and
wherein the management computer combines the data transmitted by the host computers with each other to collect the performance information of the storage system in the fourth step.

4. The performance information collecting method according to claim 2, further comprising:
a fifth step of referring, by the management computer, to the collected performance information to extract the host computer having a lower load than a predetermined threshold and the logical area having a lower load than a predetermined threshold so as to designate a correlation between the extracted host computer and the extracted logical area;
a sixth step of notifying, by the management computer, of the designated correlation;
a seventh step of transmitting, by the management computer, information in a first logical area that stores the program and information in a selected second logical area when the program is not stored in the second logical area selected by the management computer, the logical area being contained in the notified correlation; and
an eighth step of moving, by the control unit, the program stored in the first logical area to the second logical area.

5. The performance information collecting method according to claim 2, further comprising:
a fifth step of referring, by the management computer, to the collected performance information to extract the host computer having a lower load than a predetermined threshold and the logical area having a lower load than a predetermined threshold so as to designate a correlation between the extracted host computer and the extracted logical area;
a sixth step of notifying, by the management computer, of the designated correlation;
a ninth step of transmitting, by the management computer, information in a third logical area that stores performance information obtained by the program and information in a forth logical area selected by the program when the program is stored in the logical area selected by the management computer, the logical area being contained in the notified correlation; and
a tenth step of moving, by the control unit, the performance information stored in the third logical area to the forth logical area.

6. The performance information collecting method according to claim 2, further comprising:
a fifth step of referring, by the management computer, to the collected performance information to extract the host computer having a lower load than a predetermined threshold and the logical area having a lower load than a predetermined threshold so as to designate a correlation between the extracted host computer and the extracted logical area;
an eleventh step of notifying, by the management computer, of the extracted host computer and the extracted logical area when a correlation between the extracted host computer and the extracted logical area is not set;
a twelfth step of transmitting, by the management computer, information in a fifth logical area that stores the program and information in a sixth logical area, in which the correlation is set, when the program is not stored in the logical area for which the correlation with the notified host computer is set; and
a thirteenth step of moving, by the control unit, the program stored in the fifth logical area to the sixth logical area.

7. A computer system comprising:
a disk drive, in which at least one logical area that stores data is set;
a storage system comprising a control unit that controls read and write of data from and to the disk drive and an interface connected to a host computer;
the host computer connected to the interface through a network, the host computer making a request of read and write of data from and to the logical area of the disk drive; and
a management computer that collects performance information of the storage system, the network, and the host computer,
wherein a correlation between the host computer and the logical area used by the host computer is set, and
wherein the control unit obtains the performance information of the storage system, and transmits the obtained performance information to the host computer having a lower load than a predetermined threshold value,
wherein the host computer transmits the performance information transmitted from the control unit to the management computer, and
wherein the management computer collects the transmitted performance information.

8. The computer system according to claim 7, wherein the control unit stores a program that obtains the performance information, and the control unit stores the program in the logical area having a lower load than the threshold value and obtains the performance information by a processing of the stored program.

9. The computer system according to claim 8, comprising a plurality of the host computers,
wherein the control unit divides the performance information obtained by the program into at least two data, adds information that identifies the storage system to the divided data; and transmits the data, to which the identifier is added, to at least two of the host computers in a distributed manner,
wherein each of the host computers transmits the data transmitted by the control unit to the management computer, and
wherein the management computer combines the data transmitted by the host computers with each other to collect the performance information of the storage system.

10. The computer system according to claim 8, further comprising
wherein the management computer:
refers to the collected performance information to extract the host computer having a lower load than a predetermined threshold and the logical area having a lower load than a predetermined threshold so as to designate a correlation between the extracted host computer and the extracted logical area;
notifies of the designated correlation; and
transmits information in a first logical area that stores the program and information in a selected logical area when the program is not stored in the logical area selected by the management computer, the logical area being contained in the notified correlation, and
wherein the control unit moves the program stored in the first logical area to the second logical area.

11. The computer system according to claim 8, further comprising
wherein the management computer:
refers to the collected performance information to extract the host computer having a lower load than a predetermined threshold and the logical area having a lower load than a predetermined threshold so as to designate a correlation between the extracted host computer and the extracted logical area;
notifies of the designated correlation; and
transmits information in a third logical area that stores performance information obtained by the program and information in a forth logical area selected by the management computer when the program is stored in the logical area selected by the management computer, the logical area being contained in the notified correlation, and
wherein the control unit moves the performance information stored in the third logical area to the forth logical area.

12. The computer system according to claim 8, further comprising:
wherein the management computer:
refers to the collected performance information to extract the host computer having a lower load than a predetermined threshold and the logical area having a lower load than a predetermined threshold so as to designate a correlation between the extracted host computer and the extracted logical area;
notifies of the extracted host computer and the extracted logical area when a correlation between the extracted host computer and the extracted logical area is not set; and
transmits information in a fifth logical area that stores the program and information in a sixth logical area, in which the correlation is set, when the program is not stored in the logical area for which the correlation with the notified host computer is set, and
wherein the control unit moves the program stored in the fifth logical area to the sixth logical area.

13. A computer system comprising:
a disk drive, in which at least one logical area that stores data is set;
a storage system comprising: a control unit comprising a processor and a memory, the control unit controlling read and write of data from and to the disk drive; and an interface comprising a processor and a memory, the interface being connected to a host computer;
a host computer comprising a processor and a memory, the host computer being connected to the interface through a network to make a request of read and write of data from and to the logical area of the disk drive; and
a management computer comprising a processor and a memory, the management computer collecting performance information of the storage system, the network, and the host computer,
wherein a correlation between the host computer and the logical area used by the host computer is set,
the storage system is provided with a program that obtains the performance information,
wherein the control unit stores the program that obtains the performance information in the logical area; reads the stored program into the memory so as to obtain the performance information by a processing of the processor; divides the performance information obtained by the program into at least two data; adds information that identifies the storage system to the divided data; and transmits the data, to which the identifier is added, to at least two of the host computers that have a load lower than a predetermined threshold value in a distributed manner,
wherein each of the host computers transmits the data transmitted by the control unit to the management computer,
the management computer combines the data transmitted by the computers to collect performance information of the storage system,
wherein the management computer refers to the collected performance information to extract the host computer having a lower load than a predetermined threshold value and the logical area having a lower load than a predetermined threshold value so as to designate a correlation between the extracted host computer and the extracted logical area; notifies the designated correlation; and transmits information in a first logical area that stores the program and information in a selected second logical area when the program is not stored in the second logical area selected by the management computer, the logical area being contained in the notified correlation, and
wherein the control unit moves the program stored in the first logical area to the second logical area.
